(19) United States
(12) Patent Application Publication
(10) Pub. No.: US 2014/0000533 A1
(43) Pub. Date: Jan. 2, 2014

(54) Retractable Illuminated Dog Leash

(71) Applicants: Dennis Limberis, Linden, NJ (US); Joyce Limberis, Linden, NJ (US)

(72) Inventors: Dennis Limberis, Linden, NJ (US); Joyce Limberis, Linden, NJ (US)

(21) Appl. No.: 13/914,620

(22) Filed: Jun. 10, 2013

Related U.S. Application Data
(60) Provisional application No. 61/689,585, filed on Jun. 8, 2012.

(51) Int. Cl. A01K 27/00

(52) U.S. Cl. CPC A01K 27/006
USPC 119/796

(57) ABSTRACT

The invention provides a retractable illuminated dog leash, with an two LED lights providing pet owners with a sturdy leash and a flashlight that illuminates ground around one's feet and also the path ahead. The Maxine is an ergonomically designed handheld device that combines a retractable reel type pet leash with a two directional LED flashlight and serve as both leash and light, leaving a pet walker with one hand free to attend to other matters.

### CLAIM OF PRIORITY

This patent application claims priority under 35 USC 119 (e) (1) from U.S. Provisional Patent Application Ser. No. 61/689,585 filed Jun. 8, 2012, of common inventorship herewith entitled, “The Maxine Leash.”

### FIELD OF THE INVENTION

The present invention pertains to the field of pet leashes, and more specifically to the field of retractable pet leashes.

### BACKGROUND OF THE INVENTION

The prior art has put forth several designs for retractable pet leashes. Among these are:

U.S. Pat. No. 5,558,044 to Joseph E. Nassar, Jr. and Nancy M. Nasser describes an illuminated animal leash that enables a user to hold a dog leash and direct a flashlight beam easily with one hand. The leash assembly includes a handle having a grip portion and a flashlight portion. A leash having a loop at one end is connectable to the handle by a connecting mechanism which allows the loop of the leash to be removable connected to the handle. Possible connecting mechanisms include a pivotable member, a snap in connection or a clip type connection. The leash may be permanently attached to the handle as in the case of a retractable leash. The handle is preferably provided with a handle which extends at approximately a ninety degree angle to the beam of light emitted by the flashlight.

U.S. Pat. No. 6,024,054 to Brian J. Matt, Timothy J. Coonahan, Alan D. Ball, Craig A. DuBois and Bryan P. DeBlois describes a retractable leash including an integral light. The apparatus has a first housing section and a retractable leash section. The first housing section has a handle, a light connected to top front portion of the first housing section and a receiving area. A rechargeable battery is removably connected to the first housing in the handle. The retractable leash section has a second housing section pivotably mounted to the first housing section, in the receiving area, and a reel rotatably mounted to the second housing section. A leash is connected to the reel for extension and retraction relative to the first housing section. In an alternate embodiment, a light is located on the leash and electrically connected to a conductor extending along the leash.

U.S. Pat. No. 6,925,967 to Michele L. Woodruff describes an illuminated retractable leash with an animal tethering device which uses electroluminescent wire and a DC to AC inverter to illuminate not only the extendable and retractable physical tether to the animal, but also to illuminate the leash housing. Electroluminescent wire wound on a rotating spool is supplied power by an inverter circuit powered by an on board battery. A transparent spool and an at least partially transparent housing provides the capability for illuminating the housing, as well as the electroluminescent wire leash.

None of these prior art references describe the present invention.

### SUMMARY OF THE INVENTION

It is an object of the present invention to provide a reel style retractable leash with a bidirectional dual LED flashlight.

### BRIEF DESCRIPTION OF THE DRAWINGS

FIG. 1 is a prototypical diagonal side view showing a light button, a leash retract button, and two lights located above and below a retractable leash.

FIG. 2 is a functional diagonal side view showing a light button, a leash retract button, and two lights illuminated above and below a retractable leash.

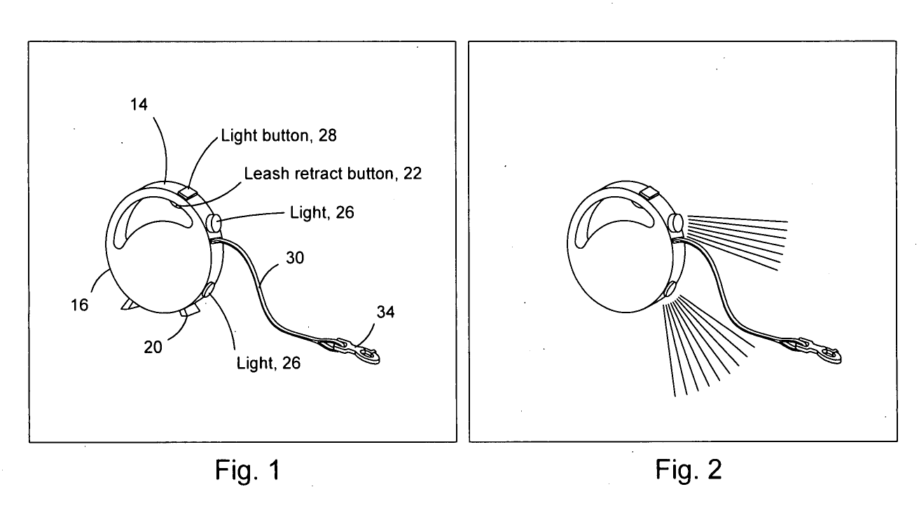

### DETAILED DESCRIPTION OF THE INVENTION

In a pet loving society, many pets are considered highly valued members of a family. For a relatively small investment, pets give so much love and are a joy and comfort when one needs good companionship. Pets, especially puppies and kittens, provide hours of entertainment and humor for both young and old pet owners. Pets teach valuable lessons in responsibility and unconditional love and devotion. In return, many pet owners are taking optimal care of their pets and providing them with good veterinary care, food, toys and sleeping beds. In addition to attending to their pet's health and comfort needs, responsible pet owners in urban and suburban locales attend to their pet's physical and mental needs by regularly walking their pet. Although cats and pot bellied pigs occasionally are walked on leashes, the most common pet walked on a leash is the dog. Dogs become beloved friends with whom a pet owner has outdoor companionship and a reason to go for a walk. A popular leash used today is a retractable reel type leash which allows a pet a certain range of movement yet permits an owner to exercise adequate control and restraint. For dog owners who rise early to walk their pets in predawn hours before work and again walk them in early evening hours or late at night, they must walk without natural light and often handle a leash in one hand and a flashlight in the other hand.

The present invention, hereinafter referred to as retractable illuminated dog leash, The Maxine Leash, or simply the Maxine, is a retractable pet leash with an LED flashlight that provides pet owners with a sturdy topflight leash and a flashlight that illuminates ground around one's feet but also the path ahead. The Maxine is an ergonomically designed handheld device that combines a retractable reel type pet leash with a two directional LED flashlight and serve as both leash and light, leaving a pet walker with one hand free to attend to other matters. Fabricated in a tough lightweight scratch and impact resistant thermoplastic polymer, the outer casing of The Maxine is circular in aspect and approximately five inches in diameter and four inches in depth or thickness. The Maxine contains an ergonomically styled, semicircular handle 14 molded into the upper arc of the casing 16 and a pair of transversely oriented pad feet 20 molded into the base of the casing to permit the present, invention to be set down in an upright position. The interior of the Maxine's casing comprises a retractable ratchet and pawl leash. The standard leash is approximately twelve to fifteen feet in length and is fabricated with a nylon braided cord containing a snap shackle or swivel clip 34 at the terminal end. This leash 30 is controllable by a sliding thumb lever switch 22 on the underside of the handle, such that it is released to full extension, locked at any position, and reeled in or retracted into the casing and wound back on to the interior spool or reel. The Maxine has two powerful LED or Light Emitting Diode lights 26 which are powered by coin batteries or rechargeable batteries and activated by a pair of buttons 28 on the top of the Maxine's handle. The first LED light 26 casts a cone of light straight ahead of the casing to illuminate a pet walker's path. The other LED light 26 casts a cone of light ahead and downward to illuminate an immediate vicinity of the pet walker's feet.

The Maxine combines a retractable pet leash and two double LED flashlights, into a single and easily used product. The Maxine combines these two necessities for those pet owners who walk their pets in low light conditions, enabling them to keep one hand free. With its unique forward and downward oriented LED configuration, The Maxine saves night and early morning pet walkers from hazards on the ground such as stepping in unsavory excrement from their pet or other people's pets. Clever in conception, thoughtful in design and affordable in price, The Maxine will find a wide and enthusiastic market among pet owners who walk their pets on leashes.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A reel style retractable leash with a bidirectional dual LED lights, comprising a retractable pet leash with two LED lights , wherein the first LED light lights the ground around the user's feet and the second LED functions as a flashlight that illuminates the path ahead.

2. The reel style retractable leash with a bidirectional dual LED lights of claim 1 comprising a tough lightweight scratch and impact resistant thermoplastic polymer, wherein the outer casing of the leash is essentially circular and approximately five inches in diameter and four inches in depth or thickness.

3. The reel style retractable leash with a bidirectional dual LED lights of claim 1 wherein a semicircular handle molded into the upper arc of the casing and a pair of transversely oriented pad feet molded into the base of the casing permitting the leash to be set down in an upright position.

4. The reel style retractable leash with a bidirectional dual LED lights of claim 1 wherein the interior of the leash casing comprises a retractable ratchet and pawl leash, wherein the leash is approximately twelve to fifteen feet in length and is fabricated with a nylon braided cord containing a snap shackle or swivel clip at the terminal end, and further wherein the leash is controllable by a sliding thumb lever switch on the top of the handle, such that it is released to full extension, locked at any position, and reeled in or retracted into the casing and wound back on to an interior spool or reel.

5. The reel style retractable leash with a bidirectional dual LED lights of claim 4, wherein the two LED or Light Emitting Diode lights are powered by coin batteries or rechargeable batteries and activated by a pair of buttons on the top of the leash handle.
